(19) United States
(12) Patent Application Publication
(10) Pub. No.: US 2017/0098280 A1
(43) Pub. Date: Apr. 6, 2017

(54) SYSTEMS AND METHODS FOR DETECTING FRAUD IN SUBSCRIBER ENROLLMENT

(71) Applicant: HealthPlan Services, Inc., Tampa, FL (US)

(72) Inventor: Aaron O'Brien, Tampa, FL (US)

(21) Appl. No.: 15/284,287

(22) Filed: Oct. 3, 2016

Related U.S. Application Data
(60) Provisional application No. 62/236,613, filed on Oct. 2, 2015.

(51) Int. Cl. G06Q 40/08

(52) U.S. Cl. CPC G06Q 40/08

(57) ABSTRACT

Systems and methods permit detection of potential fraud in subscriber enrollments. One embodiment includes a computing device associated with a provider and a database containing enrollment data. The provider computing device sorts the enrollment data into one or more benchmarking datasets and performs a recommendation analysis on each dataset to generate metrics. The metrics are used by a consolidation analysis to calculate benchmarks. The provider computing device utilizes the benchmarks to perform an indicator analysis that generates fraud indicators. A recommendation analysis processes the fraud indicators, benchmarks, and/or metrics to generates a flag indicating approval or disapproval of an enrollment.

### CROSS REFERENCE TO RELATED APPLICATION

This application claims priority from U.S. provisional application No. 62/236,613 filed Oct. 2, 2015, the entirety of which is incorporated herein.

### BACKGROUND

The present invention relates generally to the field of subscriber enrollment, and more particularly, to systems and methods for detecting potential fraud in health insurance policy enrollments.

Fraud is an enormous source of loss in the health care industry. With millions of claims submitted to insurance providers each year, detecting fraudulent claims is a challenging and resource-intensive process. Once potentially fraudulent claims are detected, the claims still must be investigated and prosecuted. Often potentially fraudulent claims are detected only after they have already been paid. However, investigating and prosecuting improperly paid claims is costly and inefficient. Additionally, such claims can be difficult to detect in cases where the claims were submitted for legitimate medical expense but should not have been paid in the first place because the policy holder was fraudulently enrolled. It would, therefore, be advantageous to provide systems capable of processing enrollment applications to detect indicia of fraud in the enrollment process before claims are improperly paid.

Accordingly, it is an object of the present invention to provide systems and methods capable of processing subscriber enrollment applications to detect potentially fraudulent enrollments.

### SUMMARY

According to one embodiment of the invention, a computer-implemented method for detecting fraudulent enrollments comprises providing a computing device associated with a provider, and one or more databases containing case data, agent NPN data, rating area data, encounter ticket data, CASS data, inconsistency data, agent CASS data, and third-party data. The provider computing device categorizes the enrollment data into at least one benchmarking dataset. A summarization analysis is performed for each benchmarking dataset, wherein the summarization analysis generates a carrier metric, a carrier-agent sublevel metric, a rating area metric, and a rating-area-agent sublevel metric. The provider computing device performs a consolidation analysis, wherein the consolidation analysis generates a carrier benchmark, a carrier-agent sublevel benchmark, a rating area benchmark, and a rating-area-agent sublevel benchmark. The provider computing device further performs an indicator analysis, wherein the indicator analysis generates at least one fraud indicator, and then performs a recommendation analysis, wherein the recommendation analysis generates a flag indicating approval or disapproval of an enrollment.

### BRIEF DESCRIPTION OF THE DRAWINGS

Features, aspects, and advantages of the present invention are better understood when the following detailed description of the invention is read with reference to the accompanying figures described below.

FIG. 1 is a hardware configuration according to one embodiment of the invention;

FIGS. 2A-2B are listings of exemplary case data fields;

FIG. 3 is an exemplary process flow diagram according to one embodiment of the invention;

FIGS. 4A-4B are listings of exemplary benchmarks and corresponding expressions;

FIGS. 5A-5D are listings of exemplary fraud indicators and corresponding expressions;

FIG. 6 is an exemplary display screen for displaying subscriber case data and fraud indicators;

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete and will fully convey the scope of the invention and enable one of ordinary skill in the art to make, use, and practice the invention.

Disclosed are systems and methods for detecting potential fraud in subscriber enrollment. The exemplary embodiments are generally described with reference to systems and methods for detecting potential fraud in health insurance enrollment. However, those of ordinary skill in the art will recognize that the systems and methods can be configured to detect potential fraud in subscriber enrollment generally, including, but not limited to, potential fraudulent enrollment in other types of insurance policies or in financial plans.

As used herein, the term subscriber administration service provider, or simply provider, generally denotes a person or entity providing services related to the administration of subscriber networks, groups, plans, policies, accounts, or other continuing commercial relationships of an indefinite or predetermined duration. The term subscriber generally denotes an individual or entity that is or was enrolled, or that has submitted an application for enrollment, in a subscriber network, group, plan, policy, account, or other continuing commercial relationship. The term subscriber may be used interchangeably with the terms customer, consumer, client, applicant, policy holder, insured, or member; provided, however, that with respect to insurance policies, the term subscriber refers to the primary policy holder, and the term member refers to dependents or other beneficiaries covered under the policy.

The term insurer refers to an entity or individual engaged in the sale, solicitation, negotiation, or underwriting of plans, policies, or other arrangements that provide a guarantee of compensation for specified loss, damage, illness, or death in return for payment of a premium or other remuneration. The term insurer is used interchangeably with the terms insurance carrier, carrier, or insurance company. The term broker denotes an individual or entity that sells, solicits, negotiates, or administers subscriber enrollments and is used interchangeably with the term agent. Brokers may be associated with, or independent from, subscriber administration service providers or insurers. Likewise, providers can be associated with or independent from insurers, and the functions of both can be performed by the same or separate entities.

Consumers purchase health insurance through a variety of channels, including public marketplaces (“exchanges”) administered by government agencies; exchanges administered by private individuals or organizations; or directly through insurers. Consumers may shop for plans with or without assistance from an agent or broker. Purchasing health insurance may be subject to a limited enrollment period outside of which consumers have limited ability to purchase insurance. Consumers initiate the enrollment process by completing a hardcopy, telephonic, or electronic application and submitting it to an exchange or directly to an insurer. Each enrollment application is assigned a unique case identification number.

To issue an insurance policy, consumers can be required to make a binder payment that is sometimes equal to the first month's premium. The coverage may not become effective until some later predefined date, such as the first day of the following month. Polices typically provide coverage for a predetermined duration, or term, and are renewed automatically or manually for successive terms. Some consumers receive monetary subsidies that reduce the cost of health insurance. Subsidies are awarded based on consumer income and family size, among other factors, and take the form of reduced premiums, tax credits applied towards premiums, or any other form of appropriate compensation.

Purchasing insurance through an exchange allows consumers to compare plans offered by different insurers. The comparison process can be streamlined by labeling plans according to one or more plan levels or classifications based on the cost of the plan and benefits offered. For instance, some exchanges label plans according to one of four plan levels: “platinum,” “gold,” “silver,” or “bronze.” Of the four categories, platinum plans offer the most desirable benefits (i.e., broader coverage and/or lower out-of-pocket medical costs) at the highest premiums, and bronze plans offer the least benefits but at the lowest premium cost.

An enormous amount of data is gathered and generated during the subscriber enrollment and administration process—particularly with respect to health insurance plans. The systems and methods of the present invention categorize this enrollment data into various subsets, or levels and sublevels of data. Subsets of enrollment data include, for example, all insurance policies issued by a particular carrier or within a given rating area over which insurance premiums (i.e., rates) will remain the same for subscribers having the same attributes (e.g., same gender, age, nonsmoker, etc.). The systems and methods calculate certain metrics across the various subsets of enrollment data and utilize the metrics to calculate benchmarks at the carrier level and agent sublevel as well as at the rating area level and agent sublevel. To determine potential fraud indicators, the agent sublevel benchmarks are compared to a predetermined threshold value or compared against corresponding carrier level and rating area level benchmarks. Agent benchmarks that are above or below the predetermined threshold value or that deviate more than a predetermined amount from the carrier level or rating area level benchmarks are taken as potential indicators of fraudulent enrollments. Agents can be flagged for further investigation if they demonstrate indicators that meet specified criteria, or “business rules,” such as: more than a certain number of overall indicators; specific indicators or combinations of indicators; or specified indicators of more than a predetermined threshold value.

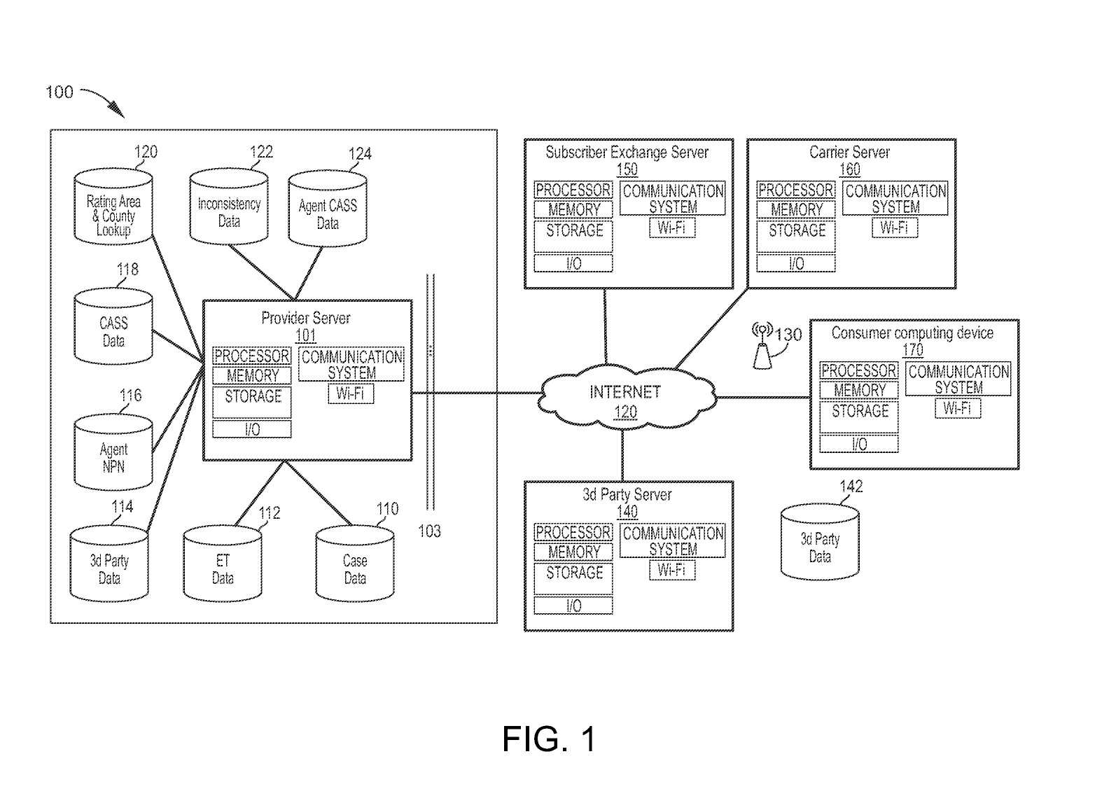

A hardware system configuration according to one embodiment of the present invention is shown in FIG. 1 and generally includes a computer system 100 associated with a provider, a computing device 170 (i.e., Internet-enabled device) associated with a consumer or agent, and network computing devices (i.e., servers) associated with a third-party information service 140, a subscriber exchange 150, and an insurance carrier 160. The provider computer system 100 includes a server 101, a firewall 103, one or more personal computing devices (not shown) operated by provider associates or employees, and a number of databases, including a case database 110, an encounter ticket (“ET”) database 112, a third-party database 114, an agent national producer number (“NPN”) database 116, a coding accuracy support system (“CASS”) database 118, a rating area and county lookup database 120 (“rating area database”), an inconsistency database 122, and an agent CASS database 124.

The consumer computing device 170, the third-party server 140, the subscriber exchange sever 150, the carrier server 160, and the components of the provider's computer system 100 include a processor that communicates with a number of peripheral subsystems via a bus subsystem. These peripheral subsystems may include a memory subsystem (e.g., random access memory), a storage subsystem (e.g., optical, magnetic, or solid-state storage), user input and output subsystems (e.g., a keyboard, mouse, computer monitor, touch-screen display, microphone, or speaker), a networking subsystem, and a communication subsystem. By processing instructions stored on a storage device or in memory, the processors may perform the steps of the methods described herein.

Typically, the provider computer system 100 communicates with other computing devices over the Internet 130 in the normal manner—e.g., through one or more remote connections, such as a Wireless Wide Area Network (“WWAN”) 132 based on 802.11 standards or a data connection provided through a cellular service provider. These remote connections are merely representative of a multitude of connections that can be made to the Internet 130.

The provider server 101 storage subsystem is loaded with computer-readable code (i.e., software) for instructing the processor to implement the steps of the methods disclosed herein. The software application is a program, function, routine, applet, or similar module that performs operations on the computing device. The application provides a graphical user interface that outputs data and information to, and accepts inputs from, a user. Types of data and information processed by the application include text, images, audio, video, or any other form of information that can exist in a computer-based environment. The graphical user interface can include various display screens that output data to a user as well as functions for accepting user inputs and commands, such as text boxes, pull-down menus, radio buttons, scroll bars, checkboxes, or other suitable functions known to one of ordinary skill in the art.

The embodiment shown in FIG. 1 is not intended to be limiting, and one of ordinary skill in the art will recognize that the system and methods of the present invention may be implemented using other suitable hardware or software configurations. For example, the provider system 100 may utilize only a single server implemented by one or more computing devices or a single computing device may implement one or more of the provider server 101, the databases, and/or the associate computing devices. Further, a single computing device may implement more than one step of the methods described herein; a single step may be implemented by more than one computing device; or any other logical division of steps may be used.

The consumer computing device 170 can be operated by a consumer or an agent acting on the consumer's behalf. The embodiment can further include multiple consumer computing devices 170, third-party servers 140, subscriber exchange servers 150, or carrier servers 160. The third-party server 140 can be maintained and operated by a government agency, a third-party information service provider, or any other individual or entity that provides data useful for implementing the invention.

The systems and methods utilize data gathered from a variety of sources, including consumer inputs, government agencies, or third-party information service providers, such as credit bureaus. The exemplary embodiment shown in FIG. 1 permits a consumer, or an agent acting on behalf of the consumer, to complete an electronic enrollment application using the consumer computing device 170. The enrollment application prompts the consumer or agent to enter a name, address, phone number, email address, date of birth, social security number, gender, age, marital status, income, or any other relevant information for the primary policy holder as well as information relating to additional beneficiaries or dependents under a policy. If the consumer or agent is purchasing a health plan from an exchange, the application data is transmitted to the exchange server 150 over the Internet 130 and stored to a database. The exchange server 150 may be maintained by a government agency that also provides third-party data 142.

The exchange server 150 assigns the application a case identification number and gathers additional information for processing the application. For example, the exchange server 150 can interface with one or more government agency computing systems to determine whether the consumer is eligible for a subsidy, and if so, what type of subsidy and the amount. The exchange server 150 processes the application and generates additional data that is appended to the case data. Application processing can include recording the date the application was submitted or calculating certain quantities from existing application data, like calculating a consumer's age based on the date of birth (“DOB.”).

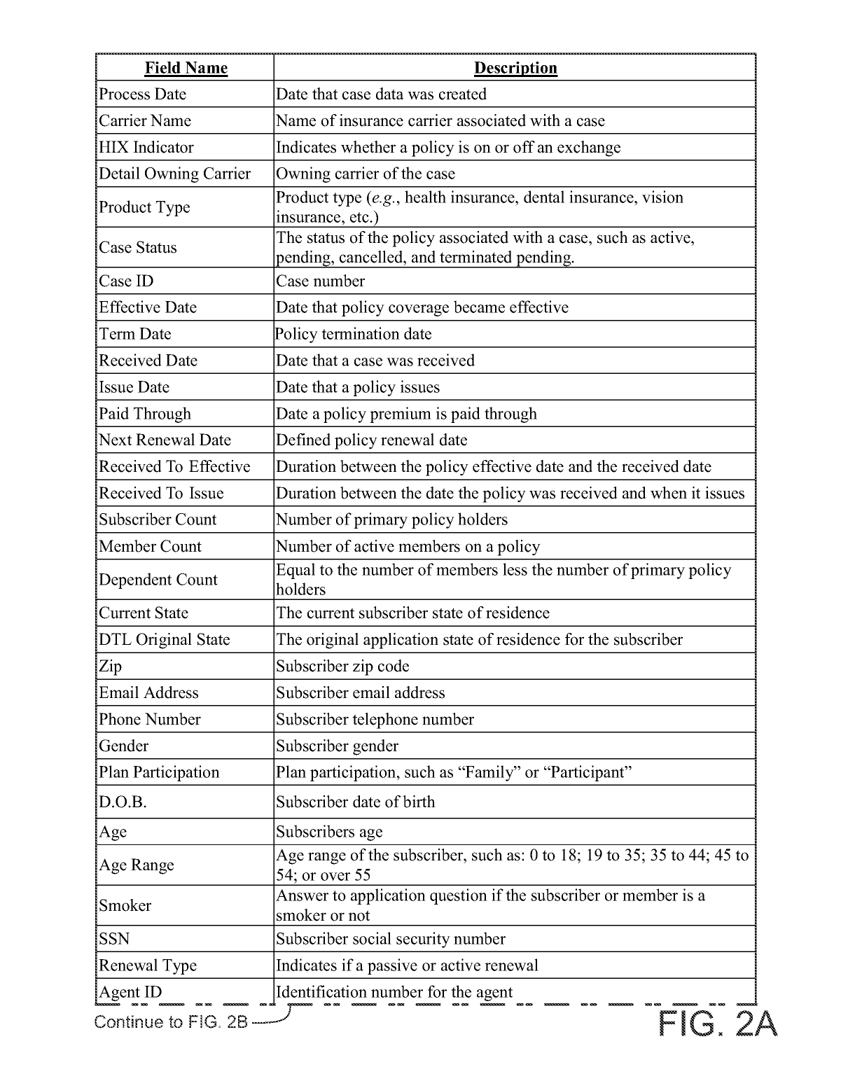

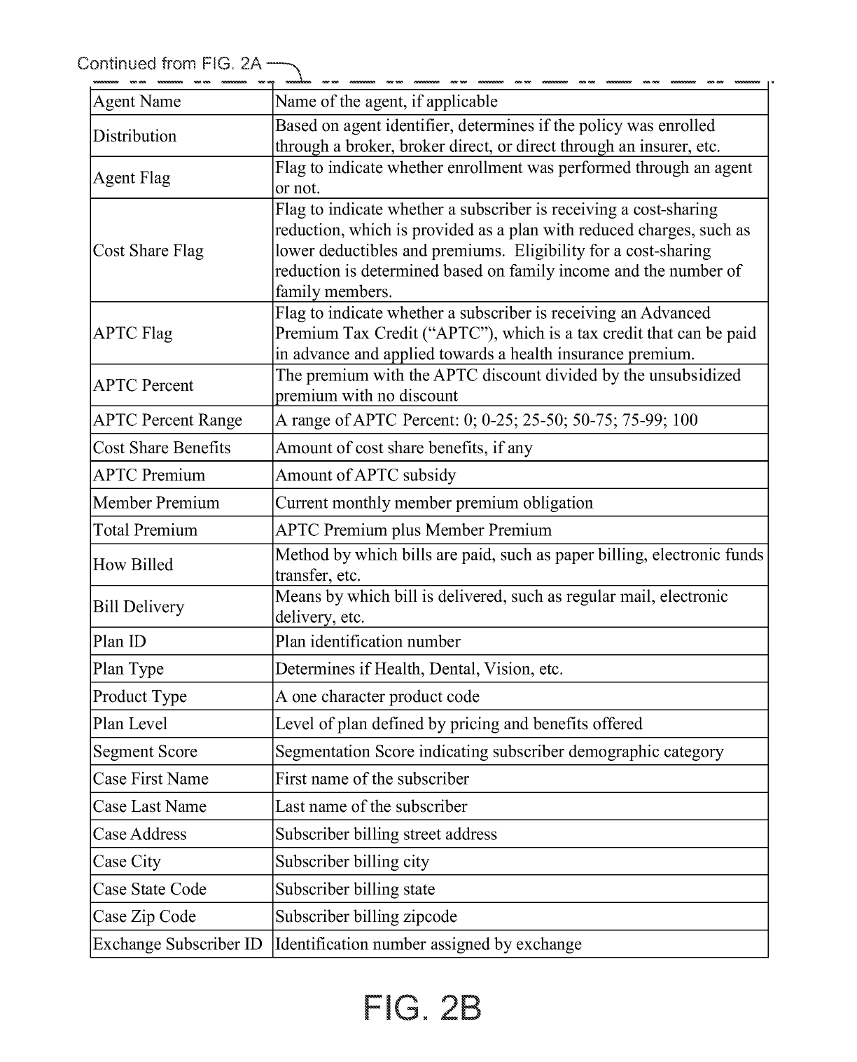

The exchange server 150 transmits the case data to the provider server 101 for further application processing and subscriber administration activities (e.g., processing premium payments, customer service activities, etc.). The case data is stored to a case database 110 on the provider computer system 100. As additional processing and administrative activities are performed, the provider server 101 updates, generates, and stores case data to the case database 110 and to other databases on the provider computer system 100. As an example, once a binder payment is made, the provider computer system 100 records the policy issuance date, updates the case status to pending, and stores the method and amount of payment. A nonexclusive listing of case database 110 fields is shown in FIG. 2.

The case database 110 stores, among other things, subscriber demographic information that is determined using subscriber biographical information, like age, income level, the number and type of dependents (i.e., spouse, young children, teenage children, etc.), and the location of the subscriber's residence, as well as other subscriber information received from third-parties. The embodiment shown in the attached figures utilizes subscriber biographic information to calculate a “Segment Score” that classifies a subscriber into a particular demographic category. The Segment Score and demographic category are stored to the case database 110. Exemplary demographic categories include: (1) established boomers; (2) blue collar workers; (3) established suburbanites; (4) aging singles; (5) single and 40s; (6) young and restless; and (7) growing families. A subscriber may be classified as an established boomer if, for example, the subscriber has an age between fifty and seventy, is married with children, and has a household income above a certain threshold. Or a subscriber could be classified as young and restless if the subscriber is below the age of thirty, has an average to low income, is well educated, single, and rents a home.

The case database 110 further includes a Case Status field indicating whether the case is active, nonterminated pending, terminated effectuated, or terminated pending. Active cases are those cases that have not been cancelled, and the binder payment has been made. Nonterminated pending cases are those where a subscriber has completed an application but not yet made the binder payment, so the case has not been effectuated. A case is classified as terminated effectuated if the plan was cancelled after a binder payment was made. And a case is terminated pending if it has been cancelled but coverage is still effective for a limited period of time.

In addition to the case database 110, the provider computer system 100 records additional information that is stored to various other database on the provider computer system 100, including the ET database 112, third-party database 114, agent NPN database 116, CASS database 118, rating area database 120, inconsistency database 122, and agent CASS database 124 (collectively “enrollment data”). The ET data stored to the ET database 112 includes information relating to customer service activities, like records of incoming customer service calls, the reason for a call, the resolution of a call, and instances of returned postal mailings.

The third-party database 114 stores, among other things, demographic data and market data available from third-party sources, like government entities, credit bureaus, and other information service providers. The third-party data stored to the third-party database 114 is obtained from the third-party server 140 after matching subscriber data from the case database 110. The third-party data is transmitted to the provider computer system 100 over the Internet 130 and stored to the third-party database 114. The third-party database 114 can store a wide variety of subscriber data, including, but not limited to subscriber marital status, family size, occupation, education, income, ethnicity, home ownership, dwelling type, and even personal interests.

The agent NPN data stored to the agent NPN database 116 is a record of all agents that have submitted enrollment applications through an exchange and include agent national producer numbers or other unique agent identifiers. The CASS database 118 stores CASS data, which is standardized address information created from subscriber mailing addresses that have been corrected or reformatted using, for instance, Coding Accuracy Support System compliant software. Address corrections include street or city name misspellings, omitted street suffixes, omitted zip codes, and the like. Similarly, agent CASS data in the form of corrected agent mailing addresses is stored to the agent CASS database 124. The rating area data stored to the rating area database 120 maps rating areas to mailing addresses and other relevant data.

The inconsistency data stored to the inconsistency database 122 indicates the existence of subscriber income or citizenship information discrepancies as well as whether a subscriber enrollment has been terminated as a result of the inconsistency. Inconsistency data can be obtained from government agencies and may or may not indicate whether the identified inconsistency is an income- or citizenship-type inconsistency. In such cases, the provider computer system 100 categorizes the inconsistency as income type based on subscriber subsidy data. If the subscriber subsidy has been reduced or eliminated, the inconsistency is classified as an income-type inconsistency given that subsidies are determined in part based on subscriber income.

The provider computer system 100 groups enrollment data from the system databases into one or more datasets that are categorized according to various levels and sublevels depending on whether specified conditions in the datasets are met. To illustrate, with reference to FIG. 2, the case database 110 is searched for all case records with an HIX Indicator of true and an Agent Flag of true, to yield a benchmarking dataset called On Exchange Broker Business, which includes all enrollments obtained through an exchange using an agent. The On Exchange Broker Business benchmarking dataset can be further grouped by insurance carrier, rating area, and agent identifier. The embodiments described utilize eight different benchmarking datasets, called benchmarking levels, that are processed by four modules: (1) the On Exchange Agent module; (2) the On Exchange Consumer module; (3) the Off Exchange Agent module; and (4) the Off Exchange Consumer module.

The On Exchange Agent Module processes the following two benchmarking levels: (a) On Exchange Broker Business—Carrier Level; and (b) On Exchange Broker Business—Rating Area Level. The On Exchange Consumer module processes the benchmarking levels: (a) All On Exchange Business—Carrier Level; and (b) All On Exchange Business—Rating Area Level.

The Off Exchange Agent module processes the benchmarking levels: (a) Off Exchange Broker Business—Carrier Level; and (b) Off Exchange Broker Business—Rating Area Level. The Off Exchange Carrier module processes the benchmarking levels: (a) All Off Exchange Business—Carrier Level; and (b) All Off Exchange Business—Rating Area Level.

Each of the four modules processes the enrollment data through one or more summarization analyses, consolidation analyses, indicator analyses, and recommendation analyses to detect and flag potentially fraudulent enrollments. The present invention will be described more fully below with reference to the analyses conducted within On Exchange Consumer module; though, each of the modules conducts the same analyses in the same or a similar manner. The On Exchange Consumer module analyzes enrollment data with an HIX Indicator of true and an Agent Flag of true or false. The enrollment data can be filtered according to the HIX flag prior to the recommendation analyses to streamline the process by narrowing the dataset on which subsequent analyses are performed.

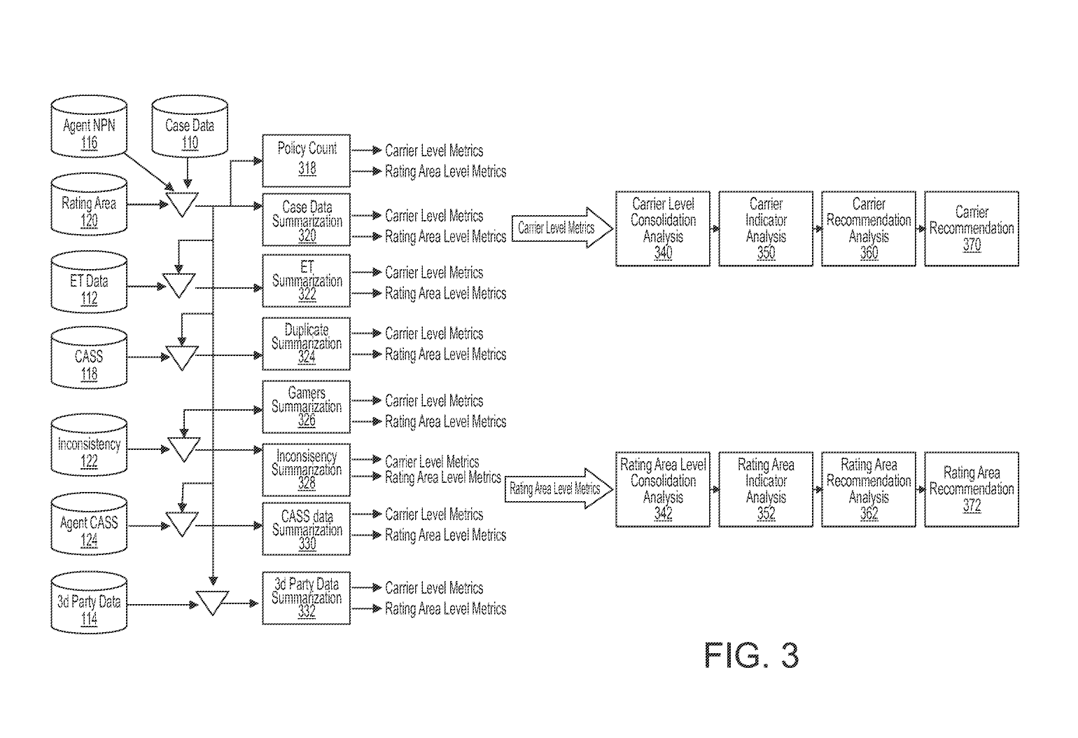

The summarization analyses calculate metrics across various levels and sublevels of the enrollment data, such as the carrier level, rating area level, or the agent level. So, for example, one metric is the total number of bronze plans enrolled by each carrier (i.e., carrier level), in each rating area (rating area level), or by each agent (agent level). The summarization analyses can further analyze the metrics across successive, nested sublevels of the enrollment data. As an example, the summarization analyses can determine the number of bronze plans enrolled in a given rating area (first level) by a particular agent (sublevel). The summarization analyses can be performed serially or in parallel, as illustrated in FIG. 3.

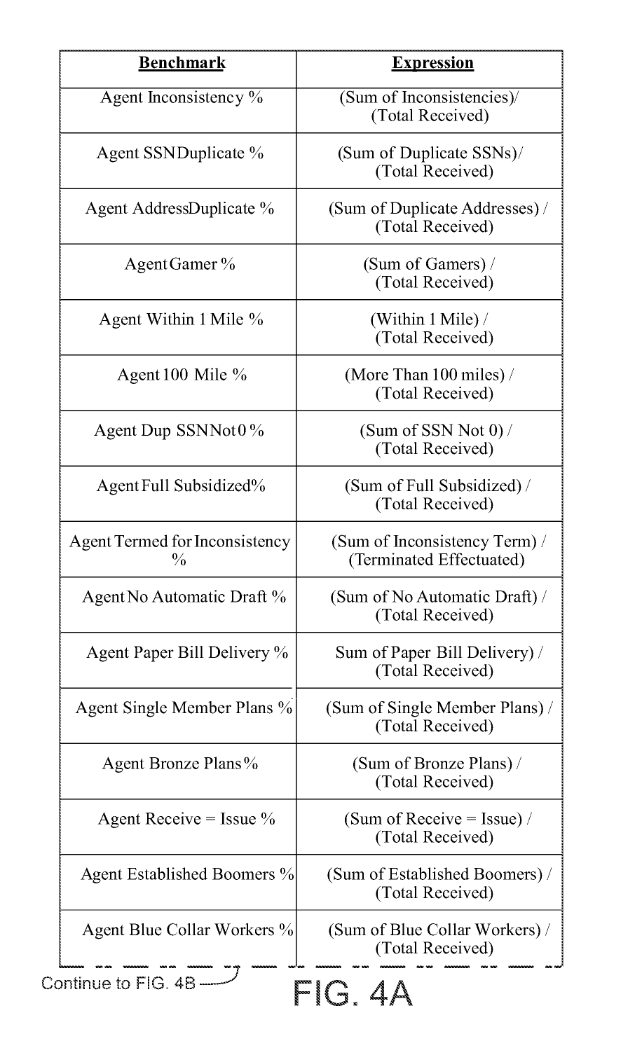

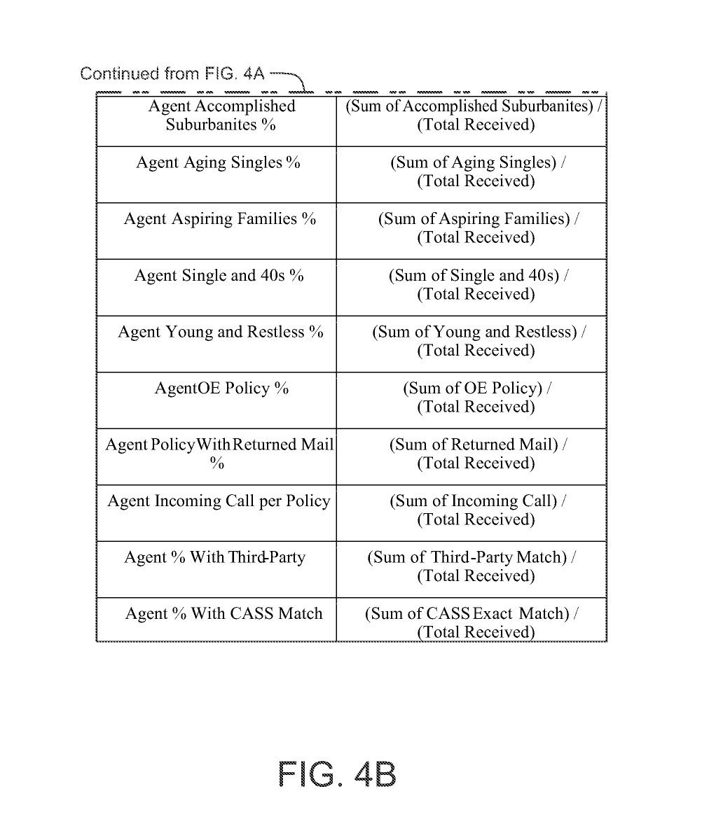

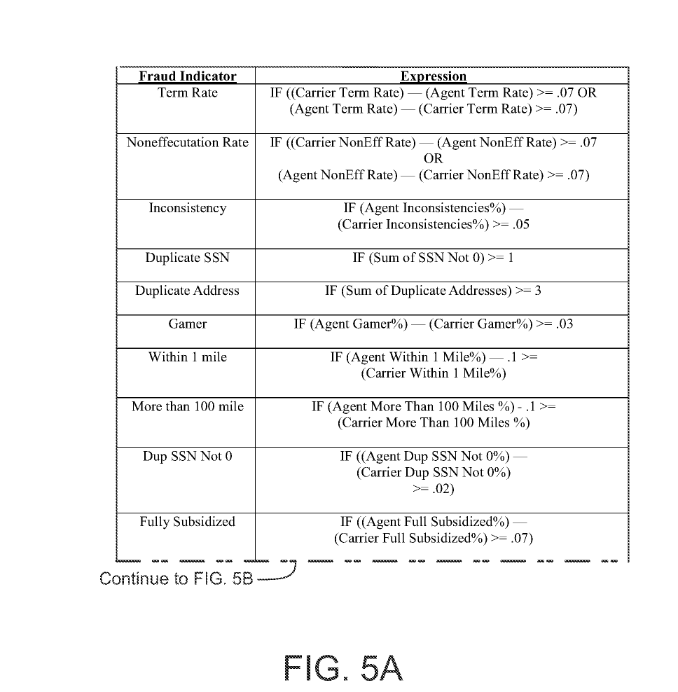

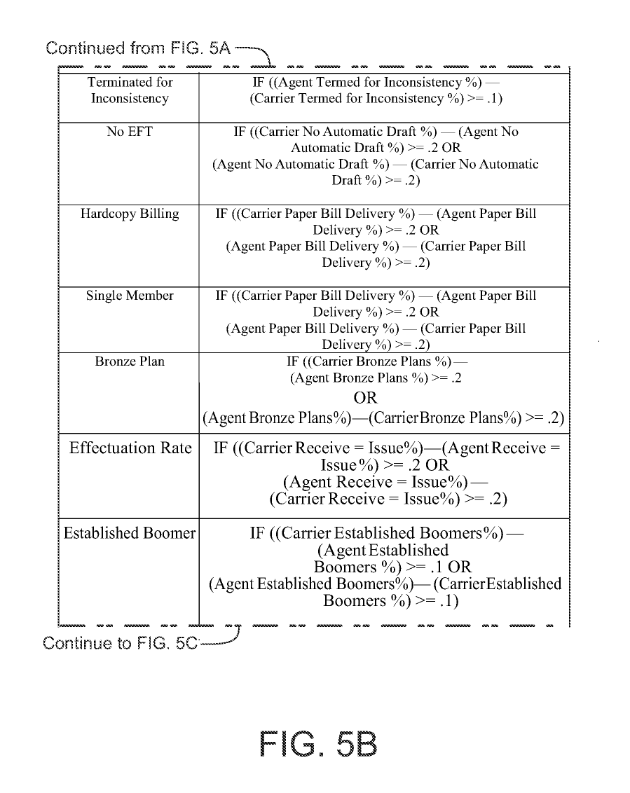

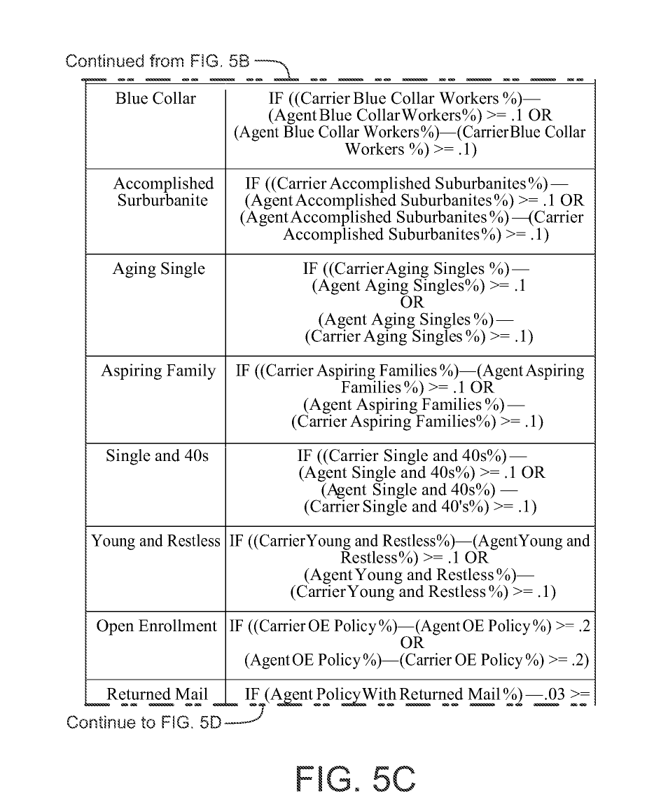

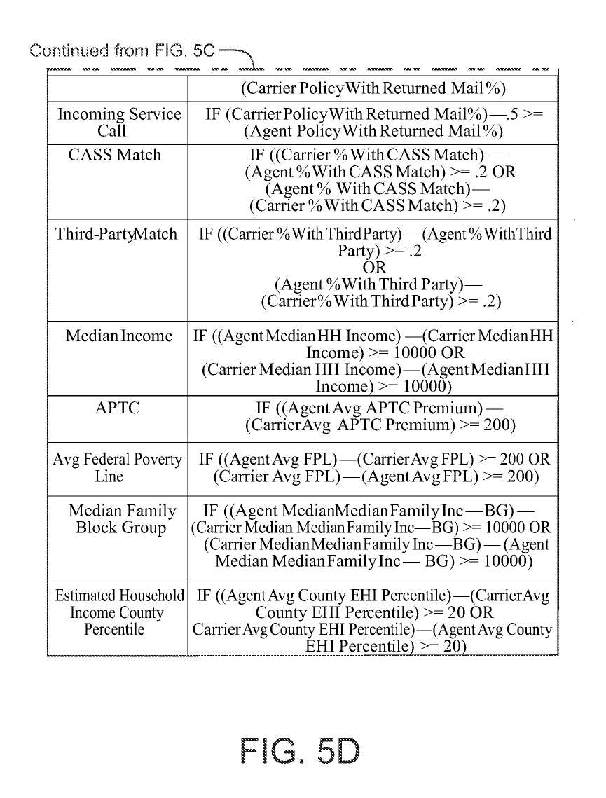

The summarization analyses in the embodiments described herein generally result in the calculation of two sets of metrics: (1) a first set calculated at the carrier level and agent sublevel; and (2) a second set calculated at the rating area level and agent sublevel. These metrics are input to the consolidation analyses to calculate benchmarks at the carrier level, rating area level, and agent sublevel. Exemplary agent sublevel benchmarks and the associated expressions for calculating the benchmarks are tabulated in FIG. 4. The carrier level and rating area level benchmarks are calculated using the same expressions except that the metrics in the expressions are calculated at the carrier level and rating area level, respectively. Exemplary metrics are shown as the numerators and denominators of the expressions in FIG. 4 and include the quantities Sum of Inconsistencies, Sum of Duplicate SSNS, Total Received, as so forth. In addition to summations, the metrics can include other calculations from the enrollment data, such as median household incomes (e.g., Agent Median HH Income and Agent Median Family Inc—BG shown in FIG. 5), income percentiles (Agent Avg County EHI Percentile and Agent Avg FPL), or premium and subsidy information (Agent Avg APTC Premium).

The indicator analyses compare the agent sublevel benchmarks against predetermined threshold values or against the carrier level or rating area level benchmarks to calculate fraud indicators at the carrier level and the rating area level. Exemplary carrier level fraud indicators and the associated expressions for calculating the fraud indicators are tabulated in FIG. 5. The rating area level fraud indicators are calculated using the same expressions except that the carrier level benchmarks are replaced with rating area level benchmarks. The embodiments shown in the attached figures implement the fraud indicators as a series of Boolean expressions that yield a value of one or zero (i.e., true or false) where a value of true represents a positive indicia of fraud.

After calculating the fraud indicators, the system performs recommendation analyses at the carrier level and the rating area level to determine whether enrollments should be flagged for further investigation as potentially fraudulent. The recommendation analyses utilize a provider business rules model 366 as well as data from the fraud indicators, benchmarks, and/or the metrics. In one embodiment, the recommendation analyses are implemented as feature-driven analyses based on a set of logical rules provided by the business rules model. The recommendation analyses can flag enrollments if a certain number of fraud indicators are determined to be true, or if a particular metric is determined to be above a predetermined threshold.

Those of ordinary skill in the art will recognize that the summarization analyses described herein are not intended to be limiting, and the systems and methods of the present invention can utilize any suitable type and number of metrics calculated at various combinations of levels or sublevels. Similarly, the consolidation and indicator analyses can be implemented with any suitable type and number of benchmarks calculated at various levels and sublevels that are useful for detecting potential indicia of fraud. The various summarization, consolidation, indicator, and recommendation analyses are discussed in more detail below.

The policy count analysis 318 receives case data 110, agent NPN data 116, and rating area data 120 and sorts the data into two sets: one dataset grouped by insurance carrier and agent identifier and a second dataset grouped by rating area and agent identifier. For each dataset, the analysis 318 counts the number of cases for each of four status types and calculates the following quantities: the total number of cases with any of the four status types (“Total Received”); the total number of effectuated cases (“Total Effectuated”); the noneffectuation rate for each agent (“Agent NonEff Rate”); and the termination rate for each agent (“Agent Term Rate”—i.e., the number of cases canceled after a binder payment was made). These quantities are calculated as follows:

Total Received=(Active Cases)+(Nonterminated Pending Cases)+(Terminated Effectuated Cases)+(Terminated Pending Cases)

Total Effectuated=(Active Cases)+(Terminated Effectuated Cases)

Agent NonEff Rate=(Terminated Pending Cases)/[(Terminated Effectuated)+(Active Cases)+(Terminated Pending Cases)]

Agent Term Rate=(Terminated Effectuated Cases)/[(Terminated Effectuated Cases)+(Active Cases)]

By grouping the input data into a first and second dataset, the case status totals, Total Received, Total Effectuated, Agent NonEff Rate, and Agent Term Rate are calculated at both the carrier level and agent sublevel and the rating area level and agent sublevel.

The case data analysis 320 receives data from the case database 110, the agent NPN database 116, and the rating area database 120. Similar to the policy count analysis 318, the case data analysis 320 starts by sorting the case data into two datasets: a first dataset sorted by insurance carrier and agent identifier; and a second dataset sorted by rating area and agent identifier. For each dataset, the case data analysis 320 identifies particular events and determines the total number of occurrences for each event. The specified events include, but are not limited to: (1) fully subsidized cases; (2) cases terminated by reason of an inconsistency; (3) subscribers that do not pay premiums by automatic electronic funds transfer; (4) subscribers that receive hardcopy billing statements by mail; (5) plans without dependents; (6) subscribers with the lowest level plan (e.g., bronze plan); (7) enrollments received on a the same day of the month; (8) cases where the policy is issued on the same day it is received; (9) subscribers that fall into a given demographic category (i.e., established boomers, blue collar workers, accomplished suburbanites, aging singles, aspiring families, single and 40, or young and restless); and (10) cases where the application was received within the enrollment period.

In addition to counting the number of occurrences for specified events, the case data analysis 320 also calculates an average Advanced Premium Tax Credit (“APTC”) premium for the first and second datasets. The APTC is a premium subsidy in the form of a tax credit that can be paid in advanced and applied towards a health insurance premium. The analysis 318 further calculates the average APTC percent, which is the subscriber premium less the APTC discount divided by the unsubsidized premium with no discount.

The ET summarization analysis 322 receives information from the case database 110, the ET database 112, the agent NPN database 116, and the rating area database 120. The ET summarization analysis 322 identifies each case with an incoming service call (“call data”) or a returned mail event (“return mail data”). The total number of incoming service calls and returned mail events is determined across all cases, and the number of calls for each case is counted. The call data and return mail data are then grouped according to insurance carrier and agent identifier and rating area and agent identifier.

The duplicate address and SSN summarization analysis 324 receives input from the case database 110, the agent NPN database 116, the CASS database 118, and the rating area database 120. The address and SSN summarization analysis 324 sorts the input data into four datasets: (1) a first dataset grouped by insurance carrier, agent identifier, SSN, and subscriber latitude and longitude; (2) a second dataset sorted by insurance carrier, agent identifier, SSN, subscriber address, and subscriber latitude and longitude; (3) a third dataset sorted by rating area, agent identifier, SSN, and subscriber latitude and longitude; and (4) a fourth dataset sorted by rating area, agent identifier, SSN, subscriber address, and subscriber latitude and longitude. Initially grouping by latitude and longitude, as well as SSN, ensures that duplicate SSNs at the same address are not counted in the analysis, which could occur if a subscriber legitimately purchased multiple insurance policies.

The first dataset is further grouped by insurance carrier, agent identifier, and SSN, and the analysis 324 counts the number of duplicate SSNs as well as the number of SSNs that are not equal to zero (a SSN of zero indicates that a subscriber SSN might not have been provided). The second dataset is grouped by insurance carrier, agent identifier, subscriber address, and subscriber latitude and longitude, and the number of duplicate addresses is determined. The third data set is grouped again by rating area, agent identifier, and SSN, and the analysis 324 counts the number of duplicate SSNs as well as the number of SSNs that are not equal to zero. Lastly, the fourth dataset is grouped again by rating area and agent identifier, and the number of duplicate addresses is counted.

The gamer summarization analysis 326 utilizes case data 110 and agent NPN data 116 to identify one or more categories of cases where subscribers or agents are potentially exploiting the rules governing subscriber enrollment to gain an improper advantage (i.e., “gaming” the system). Exemplary categories of such cases are: subscribers that cancel after only making a binder payment and no further payments (“binder payment only cases”); subscribers that apply for coverage each month of the enrollment period but do not make a binder payment until the last possible opportunity (“shoppers”); and subscribers that intentionally create gaps in health plan coverage to take advantage of coverage periods with no required premium payment (“coverage gaps”).

In one embodiment, the gamer summarization analysis 326 identifies binder payment only cases by first searching the case database 110 for cases with a terminated effectuated status and that either: (i) receive a subsidy and were terminated less than ninety days after becoming effective; or (ii) do not receive a subsidy and were terminated less than thirty days after becoming effective. The number of binder payment only cases is counted, and the resulting data is sorted into two datasets: a first dataset grouped by insurance carrier and agent identifier; and a second dataset grouped by rating area and agent identifier.

The gamer summarization analysis 326 can detect shoppers by searching for duplicate active or terminated effectuated cases that have the same insurance carrier, agent, and exchange-assigned identification number. The total number of shopper cases is counted, and the resulting data is sorted by either carrier name and agent identifier or by rating area and agent identifier. Assuming that an enrollment period extends at least through November and December of a given year and ends in January of the following year, the analysis 326 identifies coverage gap cases by first identifying active and terminated effectuated cases having the same subscriber social security number and where coverage was cancelled in November or December and re-established with the same insurance carrier the following year. The analysis 326 counts the number of such cases and calculates the gap period for each case before sorting into two datasets grouped by either insurance carrier and agent identifier or by rating area and agent identifier. The gamer summarization analysis 326 also counts the total number of all gamers (i.e., the number of binder payment only cases+the number of shoppers+the number of coverage gap cases).

The inconsistency summarization analysis 328 receives data from the case database 110 and the inconsistency database 122 and sorts the data into datasets grouped by: insurance carrier and agent identifier; and rating area and agent identifier. The analysis 328 counts the number of cases that exhibit an inconsistency as well as the number of cases that have been terminated because of an inconsistency.

The CASS data summarization analysis 330 determines the number of subscribers having a mailing address within one mile of the next closest subscriber as well as the number of subscribers with a mailing address that is greater than one-hundred miles further than the average distance between agents and subscribers for the particular insurance carrier associated with the enrollment. The CASS data summarization analysis 330 receives input data from the case database 110, agent NPN database 116, CASS database 118, rating area database 120, and agent CASS database 124. The first part of the CASS data summarization analysis 330 sorts the input enrollment data by insurance carrier with ascending subscriber longitude and latitude data (i.e., by the next closest subscriber). The distance between each subscriber and the next closest subscriber is calculated, and the resulting dataset is filtered to include only those subscribers that live within one mile of the next closest subscriber. The filtered data is then grouped into two data sets: a first dataset grouped by insurance carrier and agent identifier and a second dataset grouped by rating area and agent identifier. The number of subscribers living within one mile of the next closest subscriber is counted for each dataset.

The second part of the CASS data summarization analysis 330 utilizes the input enrollment data to calculate the distance between each subscriber and the associated agent. The resulting data is grouped by insurance carrier, and the average distance between the subscriber and agent is calculated for that carrier. Next, the data is filtered to include only those cases where the distance between the agent and the subscriber is greater than one-hundred miles further than the average for the associated carrier. The resulting filtered dataset is grouped into two datasets: a first dataset grouped by insurance carrier and agent identifier and a second dataset grouped by rating area and agent identifier. For each dataset, the number of subscribers living more than one-hundred miles further than the average distance is counted.

The third-party data summarization analysis 332 receives data from the case database 110, third-party database 114, agent NPN database 116, CASS database 118, and rating area database 120. The input enrollment data is grouped into two datasets: a first dataset by insurance carrier and agent identifier and a second dataset grouped by rating area and agent identifier. For each dataset, the analysis 332 calculates the median family income at the block group level as well as the estimated household income percentiles, and then counts the number of instances where subscriber address information from the case database 110 can be matched with a corresponding CASS address from the CASS database 118.

For each dataset, the analysis 332 also utilizes the third-party data 114 to calculate a median household income, and after determining the family size for each subscriber, the median household income is used to calculate a federal poverty line (“FPL”) percentage. The third-party data 114 is also matched against the case data 110, and the number of matches is counted (i.e., instances where case data 110 for a subscriber is matched to a record within the third-party database 114).

The carrier level consolidation analysis 340 calculates benchmarks at the carrier level and agent sublevel. The exemplary agent sublevel benchmarks shown in FIG. 4 are generally calculated as a percentage, or rate of occurrence, for certain metrics within a subset of enrollment data. To illustrate, the agent sublevel benchmark “Agent Inconsistency %” is calculated for a given agent by dividing the number of the agent's enrollments for each carrier exhibiting an inconsistency (Sum of Inconsistencies, which is determined during the inconsistency summarization analysis 328) by the total number of enrollments for that agent with that carrier (Total Received, which is determined during the policy count summarization analysis 318). Similarly, the carrier level benchmark Carrier Inconsistency % (see FIG. 5) is calculated by dividing the number of a given carrier's enrollments exhibiting an inconsistency by the total number of enrollments for that carrier (Total Received).

The agent sublevel benchmarks are input to the rating area level consolidation analysis 342, and the rating area consolidation analysis 342 calculates benchmarks at the rating area level. The rating area level benchmarks are calculated using the expressions shown in FIG. 4 except that the carrier level metrics are replaced with metrics determined at the rating area level.

After calculating the benchmarks, the system performs a carrier indicator analysis 350 by comparing the agent level benchmarks against predetermined threshold values or corresponding carrier level benchmarks. Likewise, the rating area indicator analysis 352 compares the agent sublevel benchmarks against predetermined threshold values or corresponding rating area level benchmarks. The indicator analyses 350 & 352 are performed using the expressions shown in FIG. 5 with the appropriate carrier level or rating area level benchmarks and metrics.

The indicator analyses 350 & 352 can be implemented as a series of Boolean expressions that calculate each fraud indicator as either true or false. With regard to the carrier-level indicator analysis 350, the expressions generally calculate the difference between a carrier level benchmark and a corresponding agent level benchmark. If the difference is above a predetermined threshold, the expression is true. In this manner, the system detects material deviations between the carrier (or rating area) enrollment data and agent enrollment data, with the carrier (or rating area) enrollment data serving as a baseline against which the agent enrollment data is measured. For instance, if the carrier level benchmark Carrier Aging Singles % is equal to 0.2 (i.e., 20% of the carrier's enrollments are subscribers in the aging singles demographic), and the agent sublevel benchmark Agent Aging Single % is equal to 0.5 (i.e., 50% of the agent's enrollments for that carrier are subscribers in the aging singles demographic), then the fraud indicator Aging Single in FIG. 5 would be true since the difference is greater than 10%.

Alternatively, the fraud indicator expressions can compare an agent sublevel metric against a predetermined threshold value, such as determining whether there is more than one duplicate social security number or more than three duplicate addresses for a given agent. After the fraud indicators are calculated, the indicator analyses 350 & 352 count the total number of fraud indicators that were determined to be true.

The recommendation analyses 360 & 362 utilizes the carrier and agent sublevel (or rating area and agent sublevel) fraud indicators, benchmarks, and/or metrics to flag enrollments as potentially fraudulent so that the enrollments can be further investigated or validated. The recommendation analyses 360 & 362 are implemented as feature-driven analyses based on a set of logical rules provided by the business rules model to yield a carrier level recommendation 370 or rating area level recommendation 372. As an example, the recommendation analyses 360 & 362 can be configured to flag enrollments if any one of the following three criteria is met: (1) the number of true fraud indicators is greater than ten; (2) the number of duplicate addresses is greater than three; or (3) the number of duplicate SSNs is greater than one. In yet another possible type of business rule, if two or more fraud indicators are highly correlated with instances of fraud, the recommendation analyses 360 & 362 can flag enrollments as potentially fraudulent if each of the correlated fraud indicators is determined to be true. It might be the case, for instance, that agents are known to register multiple enrollments at the same fake address and, therefore, it is useful for detecting fraud to implement a business rule that flags enrollments with a true CASS Match and a true Returned Mail fraud indicator. Any number of rules and suitable features known to those skilled in the art can be used to implement the recommendation analyses.

Enrollments flagged by the recommendation analysis can be further investigated and potential deficiencies cured through a validation analysis. In particular, the validation analysis examines fraud indicators determined to be true during the indicator analysis and investigates the fraud indicators by, for instance, requesting additional information from the subscriber or from third-party sources.

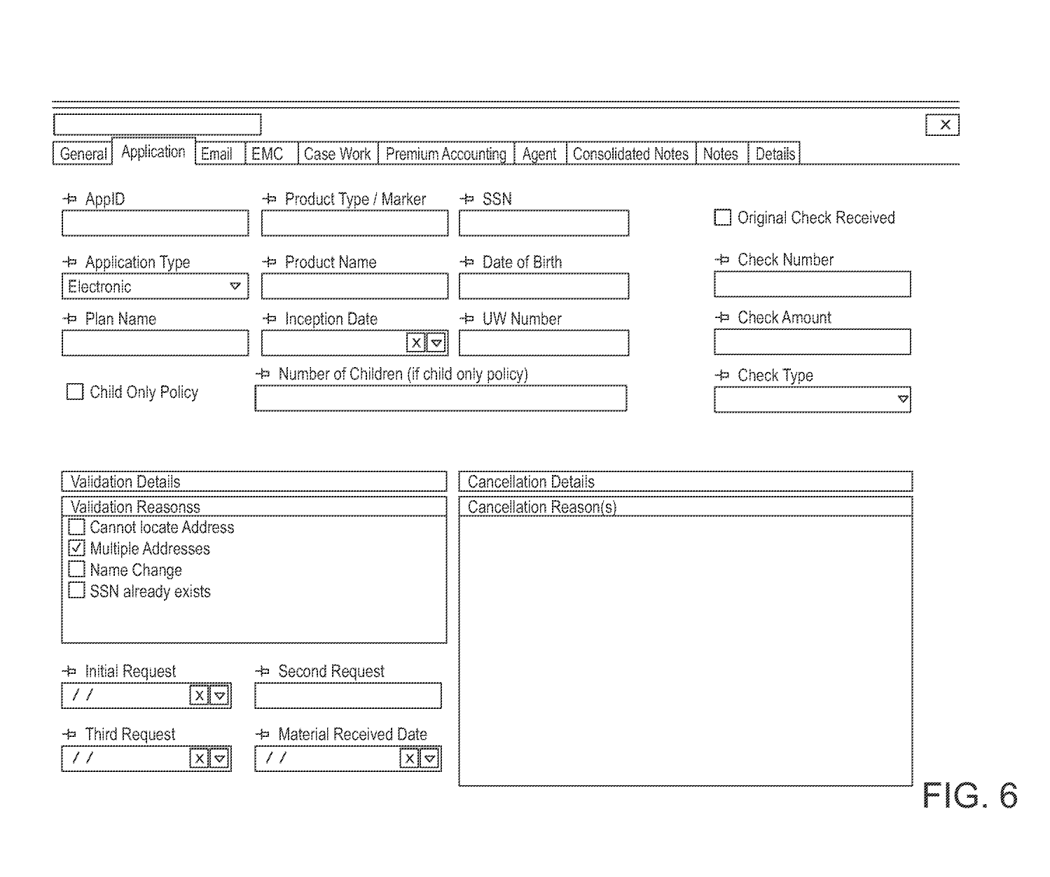

The validation analysis can be better understood with reference to the following simplified example. Case data and fraud indicators are displayed to a user through a graphical user interface, such as the display screen shown in FIG. 6. The Multiple Address checkbox is marked to let the user know that the Duplicate Address indicator (see FIG. 5) was determined to be true for that particular subscriber. The user selects the validate function (not shown) to open an address validation display screen. The address validation display screen permits the user to request validation of the subscriber's address by sending a validation request message to the subscriber. The user initiates the validation request message by first selecting an Address function or an Email function checkbox to determine where the validation request message is sent and then selecting a submit function to generate the message. The validation request message can be generated as a form letter or email to be transmitted to the subscriber.

The validation request message transmitted to the subscriber may contain a link, or universal resource locator (“URL”), that takes the subscriber to an online account portal accessed by the consumer computing device 170 over the Internet 130 in the normal manner. By selecting an upload function, the subscriber has the option to transmit documents to the subscriber computer system 100 for the purpose of validating the subscriber's address. The documents can include a recent utility bill, a bank statement, or any other suitable document that identifies the subscriber and shows an associated mailing address. Skilled artisans will appreciate that the foregoing example is not intended to be limiting, and any known technique suitable for verifying subscriber enrollment data can be utilized to implement the validation analysis.

Although the foregoing description provides embodiments of the invention by way of example, it is envisioned that other embodiments may perform similar functions and/or achieve similar results. Any and all such equivalent embodiments and examples are within the scope of the present invention.

1. A computer-implemented method for detecting fraudulent enrollments comprising:
(a) providing a provider computing device;
(b) providing at least one database containing enrollment data for at least one enrollment;
(c) sorting, by the provider computing device, the enrollment data into at least one benchmarking dataset;
(d) performing, by the provider computing device, a summarization analysis for each benchmarking dataset, wherein the summarization analysis generates at least one metric;
(e) performing, by the provider computing device, a consolidation analysis, wherein the consolidation analysis generates at least one benchmark;
(f) performing, by the provider computing device, an indicator analysis, wherein the indicator analysis generates at least one fraud indicator; and
(g) performing, by the provider computing device, a recommendation analysis, wherein the recommendation analysis generates a flag indicating approval or disapproval of an enrollment.

2. The computer-implemented method of claim 1, wherein:
(a) the at least one metric comprises a carrier level metric, a carrier agent sublevel metric, a rating area level metric, and a rating area agent sublevel metric;
(b) the consolidation analysis comprises (i) a carrier level consolidation analysis that generates a carrier level benchmark and a carrier agent sublevel benchmark, and (ii) a rating area level consolidation analysis that generates a rating area level benchmark and a rating area agent sublevel benchmark;
(c) the indicator analysis comprises (i) a carrier level indicator analysis that generates a carrier level fraud indicator, and (ii) a rating area level indicator analysis that generates a rating area level fraud indicator; and
(d) the recommendation analysis comprises (i) a carrier level recommendation analysis, and (ii) a rating area level recommendation analysis.

3. The computer-implemented method of claim 1, wherein the at least one database comprises: a case data database, an agent NPN database; a rating area database; an ET database; a CASS database; an inconsistency database; an agent CASS database; and a third-party data database.

4. The computer-implemented method of claim 3, wherein:
(a) the provider computing device comprises an On Exchange Agent module, an On Exchange Consumer Module, an Off Exchange Agent module, and an Off Exchange Consumer module;
(b) the at least one benchmarking dataset comprises (i) an On Exchange Broker Business—Carrier Level dataset, (ii) an On Exchange Broker Business—Rating Area Level dataset, (iii) an All On Exchange Business—Carrier Level dataset, (iv) an All On Exchange Business—Rating Area Level dataset, (v) an Off Exchange Broker Business—Carrier Level dataset, (vi) an Off Exchange Broker Business—Rating Area Level dataset, (vii) an All Off Exchange Business—Carrier Level dataset, and (viii) an All Off Exchange Business—Rating Area Level dataset;
(c) the On Exchange Agent module performs the summarization analysis, the indicator analysis, the consolidation analysis, and the recommendation analysis (i) on the On Exchange Broker Business—Carrier Level dataset, and (ii) on the On Exchange Broker Business—Rating Area Level dataset;
(d) the On Exchange Consumer Module performs the summarization analysis, the indicator analysis, the consolidation analysis, and the recommendation analysis (i) on the All On Exchange Business—Carrier Level dataset, and (ii) on the All On Exchange Business—Rating Area Level dataset;
(e) the Off Exchange Agent module performs the summarization analysis, the indicator analysis, the consolidation analysis, and the recommendation analysis (i) on the Off Exchange Broker Business—Carrier Level dataset, and (ii) on the Off Exchange Broker Business—Rating Area Level dataset; and
(f) the Off Exchange Consumer module performs the summarization analysis, the indicator analysis, the consolidation analysis, and the recommendation analysis (i) on the All Off Exchange Business—Carrier Level dataset, and (ii) on the All Off Exchange Business—Rating Area Level dataset.

5. The computer-implemented method of claim 4, wherein the summarization analysis comprises: (i) a policy count analysis; (ii) a case data analysis; (iii) an ET summarization analysis; (iv) a duplicate address and SSN summarization analysis; (v) a gamer summarization analysis; (vi) an inconsistency summarization analysis; (vii) a CASS data summarization analysis; and (viii) a third-party summarization analysis.

6. The computer-implemented method of claim 5, wherein:
(a) the policy count analysis utilizes enrollment data from the case data database, the agent NPN database, and rating area database;
(b) the case data analysis utilizes enrollment data from the case data database, the NPN database, and the rating area database;
(c) the ET summarization analysis utilizes enrollment data from the case data database, the ET database, the agent NPN database, and the rating area database;
(d) the duplicate address and SSN summarization analysis utilizes enrollment data from the case data database, the agent NPN database, the CASS database, and the rating area database;
(e) the gamer summarization analysis utilizes enrollment data from the case data database and the agent NPN database;
(f) the inconsistency summarization analysis utilizes enrollment data from the case data database and the inconsistency database;
(g) the CASS data summarization analysis utilizes enrollment data from the case data database, the agent NPN database, the CASS database, rating area database, and the agent CASS database; and
(h) the third-party summarization analysis utilizes enrollment data from the case data database, the third-party database, the agent NPN database, the CASS database, and the rating area database.

7. The computer-implemented method of claim 6, wherein:
(a) the provider computing device determines a segmentation score for each enrollment based on enrollment data from the case data database, wherein the segmentation score correlates to one of a plurality of demographic categories; and
(b) the policy count analysis comprises the step of determining the number of enrollments corresponding to each demographic category.

8. The computer-implemented method of claim 6, wherein the at least one benchmark comprises (i) an inconsistency percentage, (ii) a duplicate SSN percentage, (iii) a duplicate address percentage, (iv) a gamer percentage, (v) a within one mile percentage, (vi) a within 100 mile percentage, (vii) a fully subsidized percentage, (viii) a single member plan percentage, and (ix) a bronze plan percentage.

9. The computer-implemented method of claim 8, wherein the at least one fraud indicator comprises (i) a termination rate, (ii) a noneffectuation rate, (iii) a duplicate SSN indicator, (iv) a duplicate address indicator, (v) a gamer indicator, (vi) a within one mile indicator, (vii) a within 100 mile indicator, (viii) a fully subsidized indicator, (ix) a single member indicator, (x) a bronze plan indicator, and (xi) an effectuation rate.

10. The computer-implemented method of claim 6, wherein:
(a) the at least one metric comprises a carrier level metric, a carrier agent sublevel metric, a rating area level metric, and a rating area agent sublevel metric;
(b) the consolidation analysis comprises (i) a carrier level consolidation analysis that generates a carrier level benchmark and a carrier agent sublevel benchmark, and (ii) a rating area level consolidation analysis that generates a rating area level benchmark, and a rating area agent sublevel benchmark;
(c) the indicator analysis comprises (i) a carrier level indicator analysis that generates a carrier level fraud indicator, and (ii) a rating area level indicator analysis that generates a rating area level fraud indicator; and
(d) the recommendation analysis comprises (i) a carrier level recommendation analysis, and (ii) a rating area level analysis.

11. The computer-implemented method of claim 10, wherein the carrier level fraud indicator and the rating area level fraud indicator each comprise: (i) a termination rate, (ii) a noneffectuation rate, (iii) a duplicate SSN indicator, (iv) a duplicate address indicator, (v) a gamer indicator, (vi) a within one mile indicator, (vii) a within 100 mile indicator, (viii) a fully subsidized indicator, (ix) a single member indicator, (x) a bronze plan indicator, and (xi) an effectuation rate.

12. A computer-implemented method for detecting fraudulent enrollments comprising:
(a) providing a provider computing device;
(b) providing a case data database, an agent NPN database, a rating area database, an ET database, a CASS database, an inconsistency database, an agent CASS database, and a third-party data database;
(c) sorting, by the provider computing device, the enrollment data into at least one benchmarking dataset;
(d) performing, by the provider computing device, a summarization analysis for each benchmarking dataset, wherein
i. the summarization analysis generates a carrier level metric, a carrier agent sublevel metric, a rating area level metric, and a rating area agent sublevel metric, and wherein
ii. the summarization analysis comprises (A) a policy count analysis, (B) a case data analysis, (C) an ET summarization analysis, (D) a duplicate address and SSN summarization analysis, (E) a gamer summarization analysis, (F) an inconsistency summarization analysis, (G) a CASS data summarization analysis, and (H) a third-party summarization analysis;
(e) performing, by the provider computing device, a consolidation analysis comprising (i) a carrier level consolidation analysis that generates a carrier level benchmark and a carrier agent sublevel benchmark, and (ii) a rating area level consolidation analysis that generates a rating area level benchmark and a rating area agent sublevel benchmark;
(f) performing, by the provider computing device, an indicator analysis comprising (i) a carrier level indicator analysis that generates a carrier level fraud indicator, and (ii) a rating area level indicator analysis that generates a rating area level fraud indicator; and
(g) performing, by the provider computing device, a recommendation analysis generating a flag indicating approval or disapproval of an enrollment, wherein the recommendation analysis comprises (i) a carrier level recommendation analysis, and (ii) a rating area level analysis.

13. The computer-implemented method of claim 12, wherein:
(a) the provider computing device comprises an On Exchange Agent module, an On Exchange Consumer Module, an Off Exchange Agent module, and an Off Exchange Consumer module;
(b) the at least one benchmarking dataset comprises (i) an On Exchange Broker Business—Carrier Level dataset, (ii) an On Exchange Broker Business—Rating Area Level dataset, (iii) an All On Exchange Business—Carrier Level dataset, (iv) an All On Exchange Business—Rating Area Level dataset, (v) an Off Exchange Broker Business—Carrier Level dataset, (vi) an Off Exchange Broker Business—Rating Area Level dataset, (vii) an All Off Exchange Business—Carrier Level dataset, and (viii) an All Off Exchange Business—Rating Area Level dataset;
(c) the On Exchange Agent module performs the summarization analysis, the indicator analysis, the consolidation analysis, and the recommendation analysis (i) on the On Exchange Broker Business—Carrier Level dataset, and (ii) on the On Exchange Broker Business—Rating Area Level dataset;
(d) the On Exchange Consumer Module performs the summarization analysis, the indicator analysis, the consolidation analysis, and the recommendation analysis (i) on the All On Exchange Business—Carrier Level dataset, and (ii) on the All On Exchange Business—Rating Area Level dataset;
(e) the Off Exchange Agent module performs the summarization analysis, the indicator analysis, the consolidation analysis, and the recommendation analysis (i) on the Off Exchange Broker Business—Carrier Level dataset, and (ii) on the Off Exchange Broker Business—Rating Area Level dataset; and
(f) the Off Exchange Consumer module performs the summarization analysis, the indicator analysis, the consolidation analysis, and the recommendation analysis (i) on the All Off Exchange Business—Carrier Level dataset, and (ii) on the All Off Exchange Business—Rating Area Level dataset.

14. The computer-implemented method of claim 13, wherein the carrier level fraud indicator and the rating area level fraud indicator each comprise: (i) a termination rate, (ii) a noneffectuation rate, (iii) a duplicate SSN indicator, (iv) a duplicate address indicator, (v) a gamer indicator, (vi) a within one mile indicator, (vii) a within 100 mile indicator, (viii) a fully subsidized indicator, (ix) a single member indicator, (x) a bronze plan indicator, and (xi) an effectuation rate.

15. A system for detecting fraudulent enrollments comprising:
a first processor;
a data storage device including a non-transitory computer-readable medium having computer readable code for instructing the processor, and when executed by the processor, the processor performs operations comprising:
(a) providing at least one database containing enrollment data for at least one enrollment;
(b) sorting the enrollment data into at least one benchmarking dataset;
(c) performing a summarization analysis for each benchmarking dataset, wherein the summarization analysis generates at least one metric;
(d) performing a consolidation analysis, wherein the consolidation analysis generates at least one benchmark;
(e) performing an indicator analysis, wherein the indicator analysis generates at least one fraud indicator; and
(f) performing a recommendation analysis, wherein the recommendation analysis generates a flag indicating approval or disapproval of an enrollment.

16. The system for detecting fraudulent enrollments of claim 15, wherein:
(a) the at least one metric comprises a carrier level metric, a carrier agent sublevel metric, a rating area level metric, and a rating area agent sublevel metric;
(b) the consolidation analysis comprises (i) a carrier level consolidation analysis that generates a carrier level benchmark and a carrier agent sublevel benchmark, and (ii) a rating area level consolidation analysis that generates a rating area level benchmark and a rating area agent sublevel benchmark;
(c) the indicator analysis comprises (i) a carrier level indicator analysis that generates a carrier level fraud indicator, and (ii) a rating area level indicator analysis that generates a rating area level fraud indicator; and
(d) the recommendation analysis comprises (i) a carrier level recommendation analysis, and (ii) a rating area level analysis.

17. The system for detecting fraudulent enrollments of claim 16, wherein the at least one database comprises: a case data database; an agent NPN database; a rating area database; an ET database; a CASS database; an inconsistency database; an agent CASS database; and a third-party data database.

18. The system for detecting fraudulent enrollments of claim 17, wherein:
(a) the data storage device comprises an On Exchange Agent module, an On Exchange Consumer Module, an Off Exchange Agent module, and an Off Exchange Consumer module;
(b) the at least one benchmarking dataset comprises (i) an On Exchange Broker Business—Carrier Level dataset, (ii) an On Exchange Broker Business—Rating Area Level dataset, (iii) an All On Exchange Business—Carrier Level dataset, (iv) an All On Exchange Business—Rating Area Level dataset, (v) an Off Exchange Broker Business—Carrier Level dataset, (vi) an Off Exchange Broker Business—Rating Area Level dataset, (vii) an All Off Exchange Business—Carrier Level dataset, and (viii) an All Off Exchange Business—Rating Area Level dataset;
(c) the On Exchange Agent module performs the summarization analysis, the indicator analysis, the consolidation analysis, and the recommendation analysis (i) on the On Exchange Broker Business—Carrier Level dataset, and (ii) on the On Exchange Broker Business—Rating Area Level dataset;
(d) the On Exchange Consumer Module performs the summarization analysis, the indicator analysis, the consolidation analysis, and the recommendation analysis (i) on the All On Exchange Business—Carrier Level dataset, and (ii) on the All On Exchange Business—Rating Area Level dataset;
(e) the Off Exchange Agent module performs the summarization analysis, the indicator analysis, the consolidation analysis, and the recommendation analysis (i) on the Off Exchange Broker Business—Carrier Level dataset, and (ii) on the Off Exchange Broker Business—Rating Area Level dataset; and
(f) the Off Exchange Consumer module performs the summarization analysis, the indicator analysis, the consolidation analysis, and the recommendation analysis (i) on the All Off Exchange Business—Carrier Level dataset, and (ii) on the All Off Exchange Business—Rating Area Level dataset.

19. The system for detecting fraudulent enrollments of claim 18, wherein the summarization analysis comprises: (i) a policy count analysis; (ii) a case data analysis; (iii) an ET summarization analysis; (iv) a duplicate address and SSN summarization analysis; (v) a gamer summarization analysis; (vi) an inconsistency summarization analysis; (vii) a CASS data summarization analysis; and (viii) a third-party summarization analysis.

20. The system for detecting fraudulent enrollments of claim 19, wherein the carrier level fraud indicator and the rating area level fraud indicator each comprise: (i) a termination rate, (ii) a noneffectuation rate, (iii) a duplicate SSN indicator, (iv) a duplicate address indicator, (v) a gamer indicator, (vi) a within one mile indicator, (vii) a within 100 mile indicator, (viii) a fully subsidized indicator, (ix) a single member indicator, (x) a bronze plan indicator, and (xi) an effectuation rate.
